(19) United States
(12) Patent Application Publication
(10) Pub. No.: US 2026/0015260 A1
(43) Pub. Date: Jan. 15, 2026

(54) WATER CIRCULARITY IN A GAS OIL SEPARATION PLANT BY EFFECTIVE TREATMENT OF PRODUCED WATER

(71) Applicant: Saudi Arabian Oil Company, Dhahran (SA)

(72) Inventors: Ramsey James White, Abqaiq (SA); Hasan Al Abdulgader, Dammam (SA); Danah Almoshawer, Al Qatif (SA); Duaa J. Al Saeed, Al Qatif (SA)

(21) Appl. No.: 18/772,881

(22) Filed: Jul. 15, 2024

(51) Int. Cl. C02F 1/26; C02F 103/36

(52) U.S. Cl. CPC C02F 1/265; C02F 2103/365; C02F 2209/05; C02F 2209/10

(57) ABSTRACT

This technology relates to the treatment of a produced water stream to promote water circularity in a gas oil separation plant (GOSP). A wash water unit supplies a wash water stream to a desalter to desalt the crude oil in a GOSP. The desalter effluent stream is pretreated to produce a pretreated desalter effluent stream. Simultaneously, an untreated produced water stream is processed in a water oil separator (WOSEP) of a GOSP. The WOSEP produces a produced water stream and a recovered oil stream after separation. A portion of the produced water stream is pretreated and mixed with the pretreated desalter effluent stream resulting in a mixed stream. The mixed stream is desalinated to produce a permeate stream and a reject stream. The permeate stream is reused as a wash water stream in the desalter. The reject stream is recycled to either the WOSEP inlet or WOSEP outlet.

### TECHNICAL FIELD

This disclosure relates to methods of reusing produced water in a GOSP.

### BACKGROUND

Upstream processes for gas and oil separation plants (GOSPs) are components of the oil and gas industry. Extracted crude oil from the wellhead undergoes processing to allow its separation from natural gas and water. The processing units include high pressure production trap (HPPT), low pressure production trap (LPPT), dehydrator, and desalter. Salt content in the crude oil varies depending on the source of the producing well.

The presence of salt poses several operational challenges associated with refinery catalyst poisoning, equipment fouling, and corrosion, to name a few. The salt shortens the life span of downstream equipments and hinders the overall efficiency. Salt is removed from crude oil to meet product specifications, ensure reliable crude oil supply, and safeguard downstream equipment. Upstream units such as a desalter relies on fresh water sources for salt and impurity removal. However, the availability of fresh water sources is limited.

### SUMMARY

This disclosure describes technologies relating to water circularity in a GOSP by effective treatment of produced water.

### BRIEF DESCRIPTION OF DRAWINGS

FIG. 1 is a schematic drawing of a gas oil separation plant (GOSP) configuration with a desalination reject stream recycled to the inlet of a water oil separator (WOSEP).

FIG. 2 is a schematic drawing of a GOSP configuration with a desalination reject stream recycled to the outlet of a WOSEP.

FIG. 3 is a process flow diagram representing the circularity in the use of produced water in a GOSP.

### DETAILED DESCRIPTION

Treatment of produced water to generate fresh water is a complex process due to the varying concentrations and amounts of contaminants present. The contaminants vary depending on the location, maturity, geological formation of the field, and chemicals used during the production process. Examples of these contaminants include free oil, emulsified oil, volatile organic compounds, dissolved gases such as hydrogen sulfide and carbon dioxide, inorganic salts, hydrocarbons, suspended solids, and naturally occurring radioactive materials to name a few. Additionally, produced water includes total dissolved solids (TDS). The TDS in produced water needs to be reduced and removed as part of the treatment. The TDS in produced water needs to be lowered from approximately 50,000-150,000 parts per million (ppm) down to less than 2000 ppm, for the water to be reusable in the GOSP, such as wash water in desalters.

A desalter in a GOSP uses fresh water sources such as ground water to remove salts and impurities from the crude oil. This water is known as wash water. However, some GOSPs do not have access or have limited access to fresh water sources. During the initial separation and treatment of crude oil from natural gas, produced water is generated as a by-product. Produced water is considered as the largest by-product stream in oil and gas operations. The volume of produced water increases with increasing maturity of the producing field.

In implementations described in the present disclosure, the wash water stream desalts the crude oil in a desalter to generate a desalter effluent stream that includes the salts from the crude oil. The desalter effluent stream is treated in a pretreatment unit in a sequence of steps to remove organic and inorganic contaminants. The pretreated desalter effluent stream is flowed to the desalination unit. Using the pretreated desalter effluent stream, the desalination process produces a permeate stream and a reject stream. The permeate stream is reused as a wash water stream for the desalter unit. The reject stream is discharged to a water oil separator (WOSEP).

In further implementations described in this disclosure, a water oil separator (WOSEP) in a GOSP produces a recovered oil stream and a produced water stream. A first portion of the produced water stream is treated in a pretreatment unit, followed by desalination. The desalination unit processes a combined stream of a portion of the pretreated produced water stream and the pretreated desalter effluent stream. The desalination process produces a permeate stream and reject stream. The permeate stream is recycled to the desalter unit to be used as a wash water (as discussed above). The reject stream is recycled back to the WOSEP for further processing. In this manner, a circular use of the produced water stream is obtained in the GOSP.

Implementing the techniques described in this disclosure can result in one or more advantages. For example, implementing the techniques can reduce or eliminate reliance on fresh water sources and promotes a circular water economy. Furthermore, this technique uses advanced desalination methods with low salinity water. This process can recover a higher percentage of the feed water than conventional processes such as sea water reverse osmosis (RO). The process can reduce the footprint and operating expenditures to achieve a desired fresh water capacity. The following description provides details on the configuration in the GOSP to reuse a produced water stream to promote a circular water economy.

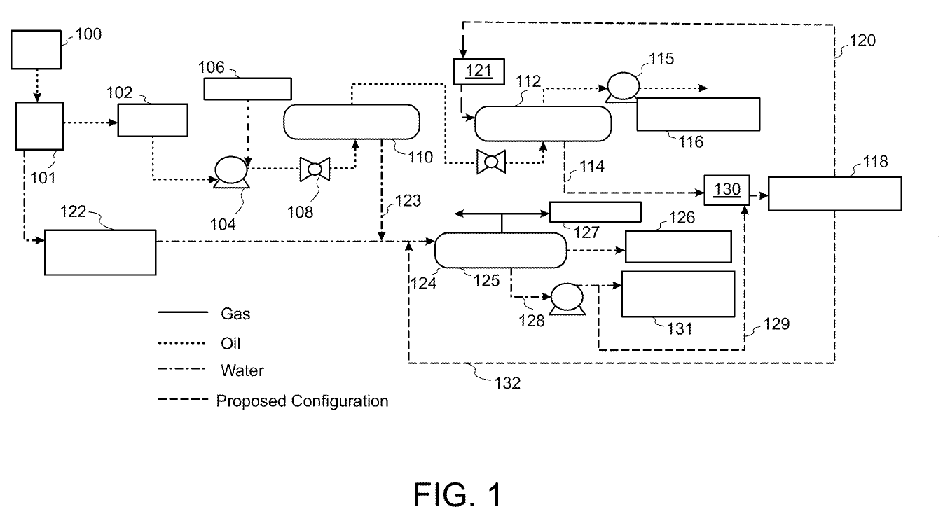

FIG. 1 is a schematic drawing of a GOSP configuration with a desalination reject stream recycled to the inlet of a WOSEP. A high pressure production trap (HPPT) 100 and a low pressure production trap (LPPT) 101 are used to separate crude oil, water, and gas. The crude oil 102 is obtained from the HPPT 100 and the LPPT 10. The crude oil 102 is processed via pump 104 along a crude oil flowline. A demulsifier 106 is injected into the crude oil flowline. A demulsifier helps to break the oil-in-water emulsions. The demulsifier can include various intermediates along with a solvent like diesel. A mixing device 108 is used to mix the demulsifier into the flowing crude oil stream. The crude oil stream with the demulsifiers flow into a dehydrator 110. The dehydrator 110 removes the water content from the crude oil stream by drying it. An electric field is applied to excite the water (brine) droplets. The water droplets coalesce into bigger water droplets and separate under gravity. The resulting stream is a dry crude oil stream.

The dry crude oil stream flows into a desalter unit 112 of the GOSP. In the desalter unit 112, salt content from the dry crude oil stream is removed by a wash water stream that flows from a wash water unit 121. This step is done to prevent corrosion of the pipelines downstream of the desalter. The desalted crude oil is pumped through a shipper pump 115 to a crude oil stabilizer unit 116. The desalting process generates a desalter effluent 114 which is directed towards a pretreatment unit 130, prior to flowing into a desalination unit 118.

The desalination unit 118 is integrated to the pretreatment unit 130 in the GOSP. A sequence of unit operations is used to remove the contaminants from the desalter effluent stream. The desalination process is mainly used to remove the dissolved ionic content from the water stream. The ionic content is referred to as TDS. The desalination process can include thermal based processes or membrane based processes. The thermal based systems heat the water and forms steam, leaving behind impurities. This can be done in a single stage or multi stage process. Membrane based processes use a high energy pump to pressurize water to move across a semi permeable membrane, leaving the dissolved salts.

Further, a separated produced water stream 122 is obtained from the HPPT and LPPT during the separation of crude oil and gas. A dehydrator effluent stream 123 is merged with the separated produced water stream 122. The separated produced water stream 122 is further received by an inlet 124 of a WOSEP 125. The separated produced water stream 122 is processed by the WOSEP 125 to produce a recovered oil stream 126, a blanket gas 127, and a produced water stream 128. The recovered oil stream 126 is recycled to the LPPT for further oil separation. The blanket gas 127 is sent to the gas processing unit. A first portion of the produced water stream 128, referred to as the make-up water stream 129, is recycled to the pretreatment unit 130. The make-up water stream 129 is combined with the desalter effluent 114 resulting in a mixed produced water stream. The mixed produced water stream undergoes a sequence of pretreatment steps in the pretreatment unit 130. The make-up water stream 129 is used to compensate for losses in the desalination unit 118.

The pretreatment unit 130 includes a sequence of units for effective removal of contaminants in the order of large oil droplets, small oil droplets, dissolved gases, volatile organic compounds (VOCs), dissolved organics, total petroleum hydrocarbons (TPH), hardness, fine colloidal particles, remaining dissolved oil and total suspended solids (TSS). The pretreated water includes a total dissolved solids (TDS) ranging between 50,000-150,000 parts per million (ppm).

For example, the large oil droplets can be removed by a hydrocyclone. The hydrocyclone includes a conical chamber in which the mixed produced water stream is spun at a centrifugal force of 800-1000 times the force of gravity. The denser water phase is forced to the outer wall of the chamber and moves towards the bottom outlet from where it is discharged. The lighter oil phase moves to the center of the chamber and migrates upward towards the top outlet. The hydrocyclone removes oil droplets between 15-20 microns.

For example, the small oil or emulsified oil droplets can be removed by a nutshell filter. The nutshell offers oil coalescing and holding capacities by trapping the oil within the tortuous pore structure. Adsorption occurs due to the nature of the oil droplets and the surface of the nutshell. The mixed produced water, free of the small and emulsified droplets are collected within the base of the vessel. The nutshell filter removes oil droplets lesser than 15 microns in size.

For example, an air stripper can be used to remove dissolved sulfur containing gases such as H₂S from the mixed produced water stream. Air stripping is also known as aeration. It mixes air with the produced water to volatilize contaminants. The volatile contaminants are directly released to the atmosphere or treated and released. Air stripping removes volatile organic compounds (VOCs). In some implementations, nitrogen, natural gas, or a suitable inert gas can be used for air stripping. In some implementations, a H₂S stripper is used. The H₂S stripper is a distillation column where the mixed produced water is heated by steam. The steam is obtained from a reboiler. As the water is heated, the H₂S gas flows upwards in the column and is stripped overhead. The obtained H₂S is of high purity and sent to the sulfur recovery unit (SRU).

For example, an adsorption media can be used to remove dissolved organics. In some implementations, activated carbon can be used as a medium to remove dissolved organics from the mixed produced water stream. Activated carbon has a large surface area making it very effective for adsorption of organics and total petroleum hydrocarbons (TPH). In some implementations, the activated carbon surface is modified to adsorb specific contaminants such as metals. In some implementations, zeolites are used as the adsorption medium. The dissolved organics include benzene, toluene, chlorinated aromatics, phenols, chlorinated aliphatics, high molecular weight hydrocarbons. In some implementations, silica gel, ion exchange resins, and polymeric adsorbents are used to remove dissolved organics.

For example, a pellet softener can be used to remove hardness from the mixed produced water stream. A pellet softener includes a tall vertical tank containing a seeding media. The commonly used seeding media is silica sand. In some implementations, the pellet softener includes a fluidized bed reactor. The key principle is the precipitation of multivalent cation carbonates.

For example, an automatic filtration unit can be used to remove fine colloidal particles from the mixed produced water stream. This prevents fouling load on a reverse osmosis (RO) membrane in the desalination unit 118. In some implementations, the mixed produced water stream undergoes cooling by a cooling system. The cooling system can include a cooling tower, an evaporative chiller, or multiple heat exchangers connected in series or parallel.

For example, a ceramic ultra filtration (UF) unit can be used to remove the remaining dissolved oil and total suspended solids (TSS) from the treated mixed produced water stream. In some implementations, the ceramic UF can be placed upstream of the cooling system. The ceramic UF can withstand temperatures up to 90-100°C. The pretreatment sequence has sampling units installed at each unit of the process. Adequate sampling ensures the specification of the mixed produced water stream meets the pre-determined water quality prior to desalination.

After pretreatment in the pretreatment unit 130, the mixed produced water stream enters the desalination unit 118. The desalination unit 118 can include a membrane based process or a thermal based process. In some implementations, the membrane based desalination unit can include an RO, ultra-high pressure RO (UHP-RO), nano filtration (NF), or micro-filtration (MF). In some implementations, the thermal based processes can include multi-stage distillation, multi-effect flash, or mechanical vapor compression.

The desalination unit 118 receives the pretreated mixed produced water stream. The pretreated mixed produced water stream is desalinated to produce a permeate stream 120 and a reject stream 132. The permeate stream has a low TDS content < 5000 ppm, which depends on the requirements for reuse in the GOSP. In some implementations, the permeate stream can have a TDS content < 500 ppm. The reject stream has a high TDS content 20,000-60,000 ppm, as all the dissolved ionic content is passed into the reject stream. As the permeate stream has most contaminants removed and has a low TDS content, it is suitable to be used as a wash water stream.

The permeate stream 120 is recycled back to the wash water unit 121. The TDS requirement for the wash water depends on the produced water TDS and the crude oil to be desalted. The wash water unit 121 receives a continuous supply of the desalinated permeate stream 120 that is used as a wash water stream for the desalter. The salinity of the wash water stream ranges between 500-5000 ppm of TDS. The TDS levels of the wash water stream are determined based on the salt content of the crude oil and the salinity of the separated produced water stream 122. The salinity of the separated produced water stream 122 can range between 50,000- 150,000 ppm of TDS which depends on the formation brine in the reservoir, the type of geological formation, and the chemicals used during the oil production process. In some implementations, the separated produced water stream 122 can have a salinity ranging between 100,000-150,000 ppm of TDS.

The reject stream 132, from the desalination unit 118, is recycled back to the WOSEP inlet 124 in this configuration. In some implementations, the reject stream 132 can have a salinity higher than the recovered produced water stream 128. In some implementations, the reject stream 132 can have a salinity lower than the recovered produced water stream 128. The salinity of the reject stream 132 depends on the recovery rate of the desalination unit 118. The WOSEP 125 further processes the reject stream 132 and dilutes the salinity of the incoming separated produced water stream 122.

A first portion of the produced water stream 128 is pretreated and desalinated which is the make-up water stream 129. However, not all of the produced water stream 128 is pretreated. A second portion of the produced water stream 128 is flowed into injection well(s) 131. It can be used for reservoir pressure maintenance or other uses, such as enhanced oil recovery purposes, or as a fracking fluid. In this way, a circularity in the usage of produced water stream is obtained in the GOSP. This configuration helps to eliminate the reliance on fresh water sources, such as a groundwater source.

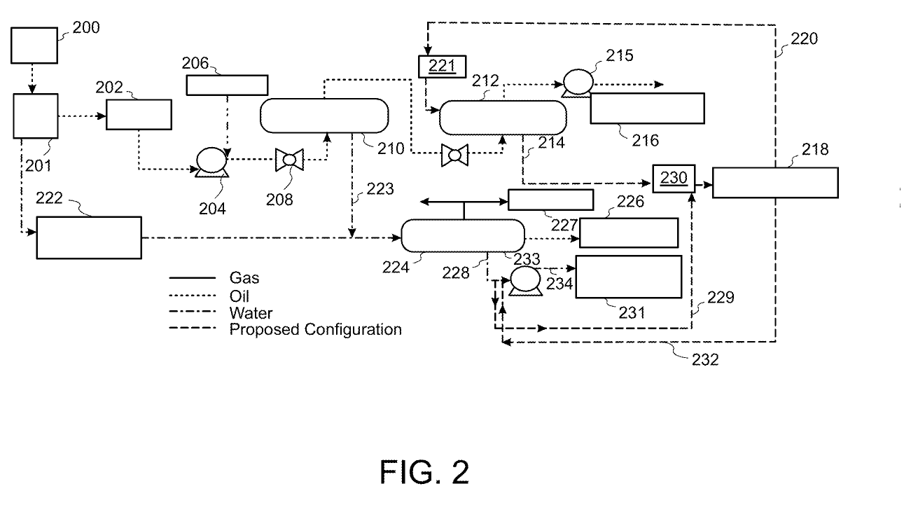

FIG. 2 is a schematic drawing of a GOSP configuration with a desalination reject stream recycled to the outlet of a WOSEP. A HPPT 200 and LPPT 201 are used to separate crude oil, water, and gas. The crude oil 202 is obtained from a HPPT 200 and LPPT 201. The crude oil 202 is directed towards a dehydrator 210 using a pump 204. Demulsifiers 206 are injected into the crude oil flowline to break the water in oil emulsions. A mixing valve 208 helps in mixing the demulsifiers into the crude oil flowline before it is received by the dehydrator 210. Similar to the description provided for FIG. 1, the moisture content is removed from the crude oil in the dehydrator 210. A dry crude oil stream is received by the desalter unit 212 of the GOSP. Desalting occurs in the desalter unit 212. A wash water unit 221, supplies a wash water stream to the desalter unit 212. The desalted crude oil is shipped via a shipper pump 215 to a crude oil stabilizer 216.

The desalter effluent stream 214 is processed by a pretreatment unit 230. The pretreatment unit 230 includes a sequence of unit operations to remove contaminants from the desalter effluent before desalinating it in the desalination unit 218. For example, the pretreatment unit 230 can include a hydroclone to remove large oil droplets. For example, a nut shell filter can be used to remove small and emulsified oil droplets. For example, an air stripper can be used to remove sulfur containing gases, ammonia, VOCs, benzene, toluene, ethylbenzene, xylenes (BTEX). In some implementations, a H₂S gas stripper can be used to remove sulfur containing gases.

For example, an adsorption media can be used to remove TPH and dissolved organics. For example, a pellet softener or a resin exchange can be used to remove hardness from the desalter effluent stream 214. For example, a microfilter (MF) or ultra filter (UF) can be used to remove fine colloidal particles to prevent plugging of the desalination membrane. In some implementations, a ceramic filtration unit can be used to remove remaining dissolved oil and dissolved organics. A ceramic filtration unit can tolerate temperatures up to 90°C. The desalter effluent 214, after pretreatment is cooled down using a cooling system. Detailed description of the above unit operations is included with the description of FIG. 1.

The desalination unit 218 can include thermal based technologies or membrane based technologies. The thermal based technologies include multi-stage distillation, multi-effect flash, or mechanical vapor compression. The membrane based technologies can include RO, UHP-RO, nano filtration, or ultra filtration. The desalination process produces a permeate stream 220 and a reject stream 232. The reject stream is also known as a make-up water stream 232. The permeate stream 220 is recycled into the wash water unit 221. The wash water TDS content is determined based on the produced water TDS and the crude oil’s salt content.

Further, the dehydrator effluent stream 223 is merged with the separated produced water stream 222. The separated produced water stream 222 is obtained from the HPPT 200 and LPPT 201 while separating crude oil and gas. The separated produced water stream 222 and dehydrator effluent stream 223 are merged and processed by a WOSEP 224. The effluent stream from the WOSEP outlet 233 includes a recovered oil stream 226, a blanket gas 227, and a produced water stream 228. The outlet from a pump fluidically coupled to the WOSEP outlet 233, flows a produced water effluent stream 234. Generally, the produced water effluent stream 234 is sent to the injection well 231 for reservoir pressure maintenance. In this configuration, a first portion of the produced water effluent stream also known as the make-up water stream 229 is processed in a pretreatment unit 230 along with the desalter effluent stream 214. The make-up water stream 229 is used for compensating water losses occurring in the desalination unit 218. The water losses in the desalination unit 218 occur during backwash of the filters and membrane cleaning. The recovery of the desalination unit can range between 60-80%. A second portion of the produced water effluent stream is sent to the injection well 231.

In some implementations, both the desalter effluent stream 214 and the make-up water stream 229 are merged and processed in the pretreatment unit 230. After pretreatment, the make-up water stream 229 is desalinated in the desalination unit 218 to produce a permeate stream 220 and a reject stream 232. The permeate stream 220 is recycled to the wash water unit 221. The permeate stream 220 has a TDS content lesser than 5000 ppm. In some implementations, the permeate stream 220 can have a TDS lesser than 500 ppm. This low TDS content makes it suitable to reuse the permeate stream 220 as a wash water stream for the desalter 212. In implementations in the current configuration, the reject stream 232 is recycled back to the produced water stream 228 that comes out of the outlet of the WOSEP 233.

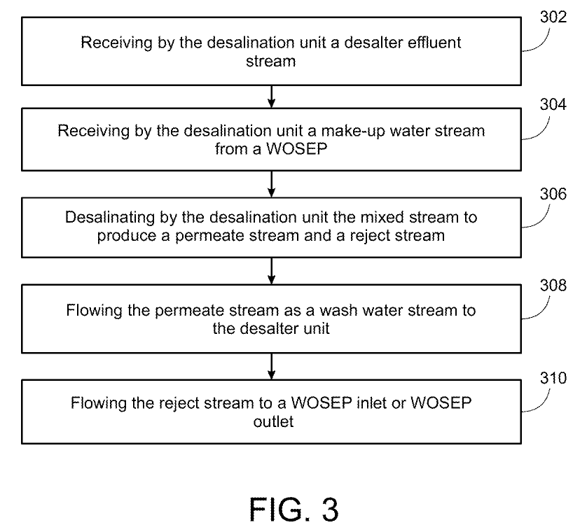

FIG. 3 is a process flow diagram representing the circularity in the use of a produced water stream in a GOSP. At block 302, a desalination unit in a GOSP receives a desalter effluent stream. The desalter effluent stream is obtained during the process of desalting a crude oil stream. The desalter effluent stream includes the salts removed out of the crude oil stream.

At block 304, the desalination unit additionally receives a make-up water stream from the WOSEP outlet. A separated water stream from a HPPT and a LPPT is obtained during crude oil separation. The separated water stream is processed by a WOSEP to produce a recovered oil stream and a produced water effluent stream. A portion of the produced water effluent stream from the WOSEP outlet is called as the make-up water. Both the make-up water stream and the desalter effluent stream flow as a mixed stream into a pretreatment unit, before flowing into a desalination unit. The pretreatment step removes contaminants such as large and small oil droplets, dissolved gases, dissolved organics, TPH, VOCs, hardness, TSS, and fine colloidal particles.

At block 306, the desalination unit desalinates the mixed stream to produce a permeate stream and a reject stream. The desalination unit can include membrane based technologies or thermal based technologies. This depends on the total dissolved solids (TDS) content in the mixed stream. For TDS levels >60,000 ppm , thermal based technologies are used. In some implementations, a UHP-RO membrane is used for TDS > 60,000 ppm. The membrane based technologies such as RO, UF, NF are used for TDS< 60,000 ppm. The RO membranes are susceptible to fouling by oil, dissolved organics, dissolved gases, hardness, TSS, and fine colloidal particles. Therefore, effective pretreatment helps to reduce fouling of the RO membranes.

At block 308, the permeate stream from the desalination unit is reused as a wash water stream in the desalter unit. At block 310, the reject stream from the desalination unit is recycled back to either the WOSEP inlet or the WOSEP outlet. A second portion of the produced water effluent stream from the WOSEP outlet is sent to the injection well for reservoir pressure maintenance, enhanced oil recovery purposes, or fracturing operations.

### EXAMPLES

Certain aspects of the subject matter described here can be implemented as a method in a GOSP. A desalination unit receives a desalter effluent stream produced by desalting a crude oil stream in a desalter of the GOSP. The desalination unit receives a make-up water stream from a WOSEP outlet. The make-up water stream is mixed with the desalter effluent stream to form a mixed stream. The desalination unit desalinates the mixed stream to produce a permeate stream and a reject stream. The permeate stream is flowed as a wash water stream to the desalter. The reject stream is flowed to the WOSEP inlet or the WOSEP outlet.

An aspect combinable with any other aspect includes the following features. The WOSEP receives a produced water stream. The produced water stream includes a water stream from a high pressure production trap, a low pressure production trap, and a dehydrator in a GOSP.

An aspect combinable with any other aspect includes the following features. The salinity of the permeate stream from the desalination unit is less than 5000 ppm.

An aspect combinable with any other aspect includes the following features. The mixed stream is pretreated before desalinating in a desalination unit.

An aspect combinable with any other aspect includes the following features. Pretreating includes removing from the mixed stream large and small oil droplets. This is followed by the removal of dissolved gases, VOCs, hardness, TSS, dissolved organics, and remaining dissolved oil before desalinating the mixed stream.

An aspect combinable with any other aspect includes the following features. A second portion of the produced water effluent stream is flowed to an injection well.

An aspect combinable with any other aspect includes the following features. The desalination unit includes a reverse osmosis membrane, a ultra-high pressure reverse osmosis membrane, a multi-stage distillation, a multi-effect flash, or a mechanical vapor compression.

Certain aspects of the subject matter described here can be implemented as a system to recycle produced water in a GOSP. The system includes a dehydrator which is configured to receive a crude oil stream for moisture removal. The dehydrator outputs a dry crude oil stream. The system includes a desalter installed downstream of the dehydrator. The desalter is configured to receive the dry crude oil stream from the dehydrator. The system includes a wash water unit installed upstream of the desalter. The wash water unit supplies a wash water stream to desalt the dry crude oil in the desalter. The system includes a WOSEP, which is configured to receive an untreated produced water stream. The WOSEP separates the untreated produced water stream to form a produced water stream and a recovered oil stream. The system includes a pretreatment unit which is configured to remove oil and a plurality of contaminants from a desalter effluent stream and a portion of the produced water stream to produce a pretreated mixed stream. The system includes a desalination unit which is configured to receive a portion of the pretreated mixed stream. The desalination unit produces a permeate stream and a reject stream. The reject stream from the desalination unit is flowed to the WOSEP inlet or the WOSEP outlet.

An aspect combinable with any other aspect includes the following features. The untreated produced water stream is obtained from the dehydrator, a high pressure production trap, and a low pressure production trap.

An aspect combinable with any other aspect includes the following features. The wash water unit is configured to receive the permeate stream from the desalination unit.

An aspect combinable with any other aspect includes the following features. The reject stream from the desalination unit is mixed with a portion of the produced water stream at the WOSEP outlet.

An aspect combinable with any other aspect includes the following features. An injection well is configured to receive a mixture of the reject stream and the portion of the produced water stream from the WOSEP outlet.

An aspect combinable with any other aspect includes the following features. The pretreatment unit includes a hydroclone, a nutshell filter, a gas stripper, a pellet softener, an automatic filter, a ceramic ultra filtration unit, a cooling system, and a sampling unit.

An aspect combinable with any other aspect includes the following features. The desalination unit includes a reverse osmosis membrane, a ultra-high pressure reverse osmosis membrane, multi-stage distillation, multi-effect flash, or mechanical vapor compression.

An aspect combinable with any other aspect includes the following features. The salinity of the produced water stream is between 10,000-150,000 ppm of total dissolved solids (TDS).

An aspect combinable with any other aspect includes the following features. The salinity of the permeate stream is less than 5000 ppm of TDS.

Certain aspects of the subject matter described here can be implemented as a method to reuse produced water. A produced water stream is received from a WOSEP in a GOSP. A first portion of the produced water stream is pretreated, resulting in a pretreated first portion of the produced water stream. A desalination unit receives the pretreated first portion of the produced water stream. The desalination unit desalinates the pretreated first portion of the produced water stream to produce a permeate stream and a reject stream. The permeate stream flows to a desalter in the GOSP and is used as a wash water stream. Further a desalter effluent from the desalter is pretreated resulting in a pretreated desalter effluent stream. The desalination unit receives the pretreated desalter effluent stream. The reject stream from the desalination unit is sent to the WOSEP inlet or the WOSEP outlet.

An aspect combinable with any other aspect includes the following features. The pretreating includes removing from the first portion of the produced water stream and the desalter effluent stream a plurality of large and small oil droplets, dissolved gases, VOCs, hardness, TSS, dissolved organics, and dissolved oil before desalination.

An aspect combinable with any other aspect includes the following features. The desalination unit receives the pretreated first portion of the produced water stream and the pretreated desalter effluent stream as a mixed stream.

An aspect combinable with any other aspect includes the following features. The desalination unit includes a reverse osmosis membrane, a ultra-high pressure reverse osmosis membrane, multi-stage distillation, multi-effect flash, or mechanical vapor compression.

Other implementations are also within the scope of the following claims.

1. A method in a gas oil separation plant (GOSP), the method comprising:
receiving, by a desalination unit, a desalter effluent stream produced by desalting a crude oil stream in a desalter of a GOSP;
receiving, by the desalination unit, a make-up water stream from a water oil separator (WOSEP), wherein the make-up water stream comprises a first portion of a produced water effluent stream from the WOSEP outlet, wherein the desalter effluent stream and the make-up water stream mix to form a mixed stream;
desalinating, by the desalination unit, the mixed stream to produce a permeate stream and a reject stream;
flowing the permeate stream as a wash water stream to the desalter; and
flowing the reject stream to a WOSEP inlet or the WOSEP outlet.

2. The method of claim 1, further comprising receiving, by the WOSEP, a produced water stream, wherein the produced water stream comprises a water stream from a high pressure production trap, a low pressure production trap, and a dehydrator in a GOSP.

3. The method of claim 1, wherein flowing a permeate stream from the desalination unit, wherein a salinity of the permeate stream is less than 5000 ppm.

4. The method of claim 1, further comprising pretreating the mixed stream before desalinating in a desalination unit.

5. The method of claim 4, wherein pretreating comprises removing from the mixed stream a plurality of large and small oil droplets, removing dissolved gases and volatile organic compounds (VOCs), removing hardness, removing total suspended solids (TSS), removing dissolved organics, and removing dissolved oils before desalinating the mixed stream.

6. The method of claim 1, further comprising flowing a second portion of the produced water effluent stream to an injection well.

7. The method of claim 1, wherein desalinating, by the desalination unit, comprises desalinating using a reverse osmosis membrane, a ultra-high pressure reverse osmosis membrane, a multi-stage distillation, a multi-effect flash, or a mechanical vapor compression.

8. A produced water recycle system in a GOSP, the system comprising:
a dehydrator configured to receive a crude oil stream, wherein the dehydrator is configured to remove moisture from the crude oil stream to output a dry crude oil stream;
a desalter downstream of the dehydrator, the desalter configured to receive the dry crude oil stream from the dehydrator;
a wash water unit upstream of the desalter, the wash water unit configured to supply a wash water stream to desalt the dry crude oil in the desalter;
a water oil separator (WOSEP) configured to receive an untreated produced water stream, and to form a produced water stream and a recovered oil stream using the untreated produced water stream;
a pretreatment unit configured to remove oil and a plurality of contaminants from a desalter effluent stream and a portion of the produced water stream to produce a pretreated mixed stream;
a desalination unit configured to receive a portion of the pretreated mixed stream to produce a permeate stream and a reject stream; and
WOSEP inlet or a WOSEP outlet configured to receive the reject stream from the desalination unit.

9. The system of claim 8, wherein the untreated produced water stream is obtained from the dehydrator, a high pressure production trap (HPPT), and a low pressure production trap (LPPT).

10. The system of claim 8, wherein the wash water unit is configured to receive the permeate stream from the desalination unit.

11. The system of claim 8, wherein the reject stream from the desalination unit is mixed with a portion of the produced water stream at the WOSEP outlet.

12. The system of claim 11, wherein an injection well is configured to receive a mixture of the reject stream and the portion of the produced water stream from the WOSEP outlet.

13. The system of claim 8, wherein the pretreatment unit comprises a hydroclone, a nutshell filter, a gas stripper, a pellet softener, an automatic filter, a ceramic ultra filtration unit, a cooling system, and a sampling unit.

14. The system of claim 8, wherein the desalination unit comprises a reverse osmosis membrane, a ultra-high pressure reverse osmosis membrane, multi-stage distillation, multi-effect flash, or mechanical vapor compression.

15. The system of claim 8, wherein the salinity of the produced water stream is between 10,10-000.,000 ppm of total dissolved solids (TDS).

16. The system of claim 8, wherein the salinity of the permeate stream is less than 5000 ppm of TDS.

17. A method to reuse produced water, the method comprising:
receiving a produced water stream from a water oil separator (WOSEP) in a gas oil separation plant (GOSP);
pretreating a first portion of the produced water stream, resulting in a pretreated first portion of the produced water stream;
receiving, by a desalination unit, the pretreated first portion of the produced water stream;
desalinating, by the desalination unit, the pretreated first portion of the produced water stream to produce a permeate stream and a reject stream;
flowing the permeate stream to a desalter in the GOSP to use as a wash water stream;
pretreating a desalter effluent stream from the desalter, resulting in a pretreated desalter effluent stream;
receiving, by the desalination unit, the pretreated desalter effluent stream;
flowing the reject stream from the desalination unit to a WOSEP inlet or the WOSEP outlet.

18. The method of claim 17, wherein pretreating comprises removing from the first portion of the produced water stream and the desalter effluent stream a plurality of large and small oil droplets, removing dissolved gases and volatile organic compounds (VOCs), removing hardness, removing total suspended solids (TSS), removing dissolved organics, and removing dissolved oils before desalination.

19. The method of claim 17, wherein receiving by the desalination unit comprises receiving the pretreated first portion of the produced water stream and the pretreated desalter effluent stream as a mixed stream.

20. The method of claim 19, wherein desalinating, by the desalination unit, comprises desalinating using a reverse osmosis membrane, a ultra-high pressure reverse osmosis membrane, multi-stage distillation, multi-effect flash, or mechanical vapor compression.
